(19) United States
(12) Patent Application Publication
(10) Pub. No.: US 2015/0253720 A1
(43) Pub. Date: Sep. 10, 2015

(54) IMAGE FORMING APPARATUS AND IMAGE FORMING METHOD

(71) Applicant: Konica Minolta, Inc., Tokyo (JP)

(72) Inventors: Kazunori KURIMOTO, Tokyo (JP); Masahiko KURACHI, Tokyo (JP); Takeshi ISHIDA, Tokyo (JP); Hokuto HATANO, Tokyo (JP)

(21) Appl. No.: 14/641,891

(22) Filed: Mar. 9, 2015

(30) Foreign Application Priority Data
Mar. 10, 2014 (JP) 2014-046068

(51) Int. Cl. G03G 15/00

(52) U.S. Cl. CPC G03G 21/0005

(57) ABSTRACT

An image forming apparatus includes an electrophotographic photoreceptor, a proximity-type charging unit to negatively charge the surface of the photoreceptor, an exposing unit to form an electrostatic latent image on the surface of the photoreceptor, a developing unit to develop the electrostatic latent image with a toner to form a toner image, a transferring unit to transfer the toner image onto a transfer medium, a fixing unit to fix the transferred toner image on the transfer medium, and a cleaning unit to remove residual toner on the photoreceptor. The photoreceptor comprises a conductive support, a photosensitive layer formed over the conductive support, and a protective layer formed over the photosensitive layer. The protective layer of the photoreceptor contains a binder resin, a particulate P-type semiconductor, and a particulate cross-linked resin composed of an insulating cross-linked polymer.

### BACKGROUND OF THE INVENTION

1. Field of the Invention

The present invention relates to an image forming apparatus including an electrophotographic photoreceptor and relates to an image forming method.

2. Description of Related Art

A typical electrophotographic image forming apparatus, such as a copier or a printer, includes an electrophotographic photoreceptor (hereinafter also referred to simply as “photoreceptor”). The photoreceptor is required to have a long service life and to form an image of stable quality. The service life of the photoreceptor is determined by wear of its surface. Fine scratches on the photoreceptor surface caused by wear, and uneven wear of the photoreceptor impair the quality of a formed image.

A recently developed organic photoreceptor includes a conductive support, an organic photosensitive layer disposed over the conductive support, and a cured resin protective layer formed over the photosensitive layer. Such a photoreceptor achieves high wear resistance, scratch resistance, and environmental stability, leading to a prolonged service life.

A typical conventional electrophotographic image forming apparatus includes a charging unit utilizing corona discharge, such as a scorotron charging unit. Unfortunately, such a charging unit utilizing corona discharge may generate ozone or nitrogen oxides during an image forming process. In view of this problem, attention has recently been paid to a proximity-type charging unit in which the surface of a photoreceptor is charged by bringing a conductive charging roller into proximity to or into contact with the photoreceptor, because such a charging unit can considerably reduce generation of ozone or nitrogen oxides, and facilitates a reduction in size of an image forming apparatus.

Unfortunately, in an image forming apparatus including a proximity-type charging unit, the surface of the photoreceptor is rapidly degraded due to direct discharge onto its surface. Thus, the photoreceptor is more likely to be worn than that of an image forming apparatus including a contactless charging unit, such as a scorotron charging unit, resulting in poor cleaning or toner filming, which causes the uneven density of a formed image or generation of streaks on the image.

A technique has been proposed for improving the wear resistance of a photoreceptor to be mounted in an image forming apparatus including a conventional contactless charging unit. The technique involves, for example, incorporation of a high-strength conductive filler into a protective layer of the photoreceptor, or bonding of a charge transporting agent having a radically polymerizable group to a binder resin through curing of the charge transporting agent together with a polyfunctional radically polymerizable compound for forming the binder resin (see, for example, Japanese Unexamined Patent Application Publication No. 2008-233206).

Unfortunately, if an image forming apparatus including a photoreceptor whose protective layer contains the conductive filler uses a proximity-type charging unit, wear of the protective layer is induced. This problem is conceivably due to the fact that discharge from the charging unit concentrates on the conductive filler, and electrons generated by the discharge enter the protective layer, leading to wear of the surface of the protective layer.

The photoreceptor composed of the cured resin bonded to the charge transporting agent having a radically polymerizable group may cause poor image stability, because the surface of the photoreceptor is less likely to be refreshed by wear, and thus the charge transporting agent degraded by discharge from the charging unit will remain on the surface of the protective layer.

Another technique has been proposed for improving the wear resistance of a photoreceptor to be mounted in an image forming apparatus including a conventional contactless charging unit, thereby improving image stability. The technique involves, for example, incorporation of P-type semiconductor particles into a protective layer of the photoreceptor (see, for example, Japanese Unexamined Patent Application Publication No. 2013-130603).

Unfortunately, if an image forming apparatus including a photoreceptor whose protective layer contains the P-type semiconductor particles uses a proximity-type charging unit, wear of the protective layer is induced.

### SUMMARY OF THE INVENTION

The present invention has been accomplished in view of such circumstances. An object of the invention is to provide an image forming apparatus and an image forming method to form an image with high stability, using an electrophotographic photoreceptor exhibiting high wear resistance even to negative charging with a proximity-type charging unit.

According to a first aspect of a preferred embodiment of the present invention, there is provided an image forming apparatus including: an electrophotographic photoreceptor; a proximity-type charging unit to negatively charge a surface of the electrophotographic photoreceptor; an exposing unit to form an electrostatic latent image on the surface of the electrophotographic photoreceptor; a developing unit to develop the electrostatic latent image with a toner to form a toner image; a transferring unit to transfer the toner image onto a transfer medium; a fixing unit to fix the transferred toner image on the transfer medium; and a cleaning unit to remove residual toner on the electrophotographic photoreceptor, wherein the electrophotographic photoreceptor includes a conductive support, a photosensitive layer formed over the conductive support, and a protective layer formed over the photosensitive layer; and the protective layer of the electrophotographic photoreceptor contains a binder resin, a particulate P-type semiconductor, and a particulate cross-linked resin composed of an insulating cross-linked polymer.

Preferably, the particulate P-type semiconductor is composed of a compound represented by Formula (1):

CuMO₂ Formula (1):

where M represents an element belonging to Group 13 of a periodic table.

Preferably, the particulate cross-linked resin is selected from a particulate silicone resin, a particulate melamine-formaldehyde condensation resin, and a particulate cross-linked polymer containing poly(methyl methacrylate).

Preferably, a ratio A/B of a number average primary particle size A of the particulate cross-linked resin to a number average primary particle size B of the particulate P-type semiconductor satisfies Formula (2):

2≦A/B≦10. Formula (2):

Preferably, the binder resin contained in the protective layer of the electrophotographic photoreceptor is a cured resin prepared through photopolymerization of a compound having two or more radically polymerizable functional groups.

Preferably, the proximity-type charging unit is a charging roller.

Preferably, the particulate P-type semiconductor has a number average primary particle size of 0.02 to 0.1 μm.

Preferably, the particulate P-type semiconductor is contained in an amount of 50 to 150 parts by mass relative to 100 parts by mass of the binder resin in the protective layer.

Preferably, the particulate cross-linked resin has a number average primary particle size of 0.1 to 1.0 μm.

According to a second aspect of a preferred embodiment of the present invention, there is provided an image forming method to form an image using an electrophotographic photoreceptor, the method including: negatively charging a surface of the electrophotographic photoreceptor; forming an electrostatic latent image on the surface of the electrophotographic photoreceptor; developing the electrostatic latent image with a toner to form a toner image; transferring the toner image onto a transfer medium; fixing the transferred toner image on the transfer medium; and removing residual toner on the electrophotographic photoreceptor, wherein the electrophotographic photoreceptor includes a conductive support, a photosensitive layer formed over the conductive support, and a protective layer formed over the photosensitive layer; and the protective layer of the electrophotographic photoreceptor contains a binder resin, a particulate P-type semiconductor, and a particulate cross-linked resin composed of an insulating cross-linked polymer.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a cross-sectional view illustrating an exemplary configuration of an image forming apparatus according to the invention;

FIG. 2 is a partial cross-sectional view illustrating an exemplary layer configuration of an electrophotographic photoreceptor of the image forming apparatus according to the invention;

FIG. 3 is a cross-sectional view illustrating an exemplary configuration of a charging roller of the image forming apparatus illustrated in FIG. 1; and

FIG. 4A and FIG. 4B are each a partially enlarged cross-sectional view illustrating a protective layer of the electrophotographic photoreceptor illustrated in FIG. 2.

### DESCRIPTION OF THE PREFERRED EMBODIMENTS

The present invention will now be described in detail.

### [Image Forming Apparatus]

An image forming apparatus according to the invention includes a proximity-type charging unit which negatively charges the surface of a photoreceptor. In the image forming apparatus, a charging roller, which is the charging unit, may be in contact with or in proximity to the photoreceptor.

FIG. 1 is a cross-sectional view illustrating an exemplary configuration of the image forming apparatus according to the invention.

The image forming apparatus includes a cylindrical photoreceptor 10, a charging unit, an exposing unit 12, a developing unit 13, a transferring unit 14, a fixing unit 17, and a cleaning unit 18. The photoreceptor 10 serves as a carrier for an electrostatic latent image. The charging unit includes a charging roller 11 which uniformly negatively charges the surface of the photoreceptor 10 by, for example, corona discharge of the same polarity as that of a toner, and a cleaning roller 15 which cleans the charging roller 11. The exposing unit 12 forms an electrostatic latent image on the uniformly charged surface of the photoreceptor 10 through exposure based on image data with, for example, a polygon mirror. The developing unit 13 includes a rotary developing sleeve 13a and develops the electrostatic latent image into a toner image by conveying a toner retained on the sleeve 13a to the surface of the photoreceptor 10. The transferring unit 14 transfers the toner image onto a transfer medium P as appropriate. The fixing unit 17 fixes the toner image on the transfer medium P. The cleaning unit 18 includes a cleaning blade 18a for removing a residual toner from the photoreceptor 10.

### [Photoreceptor]

The photoreceptor of the image forming apparatus according to the invention is an organic photoreceptor including a conductive support, an organic photosensitive layer, and a protective layer disposed in sequence. Specifically, the photoreceptor may have the following layer configuration (1) or (2):

(1) a layer configuration including a conductive support, an intermediate layer, an organic photosensitive layer including a charge generating sublayer and a charge transporting sublayer, and a protective layer disposed in sequence; or

(2) a layer configuration including a conductive support, an intermediate layer, a single organic photosensitive layer containing a charge generating material and a charge transporting material, and a protective layer disposed in sequence.

As used herein, the term “organic photoreceptor” refers to an electrophotographic photoreceptor containing an organic compound that has at least one of a charge generating function and a charge transporting function, which are essential for the electrophotographic photoreceptor. The organic photoreceptor encompasses all known organic photoreceptors, such as a photoreceptor including an organic photosensitive layer formed of a known organic charge generating material or organic charge transporting material, and a photoreceptor including an organic photosensitive layer formed of a polymer complex having a charge generating function and a charge transporting function.

A photoreceptor having the aforementioned layer configuration (1) will now be described in detail.

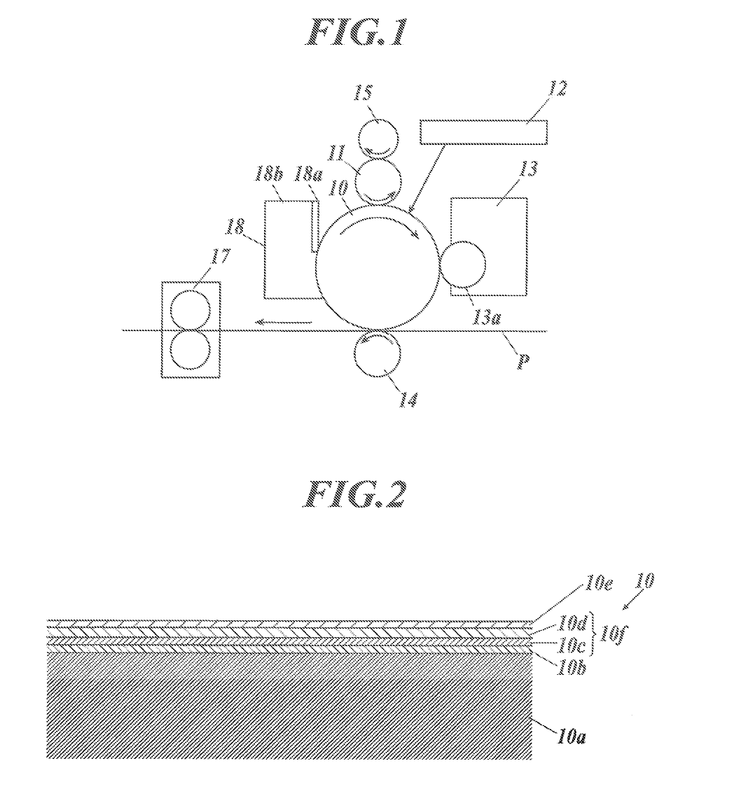

The photoreceptor having the aforementioned layer configuration (1) is, for example, a photoreceptor 10 illustrated in FIG. 2. The photoreceptor 10 includes a conductive support 10a, an intermediate layer 10b, a charge generating sublayer 10c, a charge transporting sublayer 10d, and a protective layer 10e disposed in sequence. The charge generating sublayer 10c and the charge transporting sublayer 10d form an organic photosensitive layer 10f essential for the organic photoreceptor. The protective layer 10e contains cross-linked resin particles 10eA and P-type semiconductor particles 10eB (see FIG. 4).

### [Protective Layer 10e]

The protective layer of the photoreceptor according to the invention contains a binder resin, P-type semiconductor particles, and cross-linked resin particles formed of an insulating cross-linked polymer.

The image forming apparatus according to the invention includes the photoreceptor having the protective layer containing a binder resin, P-type semiconductor particles, and cross-linked resin particles. This configuration enables the photoreceptor to exhibit high wear resistance even to negative charging with a proximity-type charging unit, and thus provides a formed image with high stability.

The possible reason for this is as follows: The number of electrons passing through the protective layer containing the P-type semiconductor particles is smaller than that of electrons passing through a conventional protective layer containing a common conductive filler, because the P-type semiconductor particles have a resistance higher than that of the conductive filler. In addition, the presence of both the P-type semiconductor particles and the cross-linked resin particles in the protective layer reduces points which receive discharge from the charging roller on the surface of the photoreceptor, leading to a further reduction in the number of electrons passing through the protective layer.

[P-Type Semiconductor Particles 10eB]

The P-type semiconductor particles, charge carriers of which are holes, contribute to image stability.

In the present invention, the P-type semiconductor particles are preferably formed of a compound represented by Formula (1):

CuMO₂ Formula (1):

where M represents an element belonging to Group 13 of the periodic table.

Specific examples of the element belonging to Group 13 of the periodic table include boron (B), aluminum (Al), gallium (Ga), indium (In), and thallium (Tl). In the present invention, the element is preferably aluminum, gallium, or indium.

In the present invention, the compound represented by Formula (1) is preferably, for example, CuAlO₂, CuGaO₂, or CuInO₂.

The P-type semiconductor particles preferably have a number average primary particle size of 0.02 to 0.1 μm, more preferably 0.05 to 0.1 μm.

The number average primary particle size of the P-type semiconductor particles is determined as follows. The particles are photographed with “JEM-2000FX” (manufactured by JEOL Ltd.) at an accelerating voltage of 80 kV and a magnification of 50,000. The photographic image is captured with a scanner and is binarized by an image processing analyzer “LUZEX (registered trademark) AP” (manufactured by Nireco Corporation), to determine the horizontal Feret's diameters of any 100 P-type semiconductor particles and to calculate the average value thereof. As used herein, the “horizontal Feret's diameter” refers to the length of a side (parallel to the x-axis) of a rectangle circumscribing a binarized image of a P-type semiconductor particle.

The P-type semiconductor particles can be produced by, for example, a plasma process. Examples of the plasma process include a DC plasma arc process, an RF plasma process, and a plasma jet process.

The DC plasma arc process can produce the P-type semiconductor particles by heating and evaporation of a metal alloy, serving as a consumption anode, with a plasma flame generated from a cathode, and then oxidization and cooling of the metal alloy vapor.

The RF plasma process utilizes a thermal plasma generated through heating of a gas by RF induction discharge at atmospheric pressure. The plasma evaporation process, which is a type of the RF plasma process, can produce the P-type semiconductor particles through injection of solid particles into an inert gas plasma, evaporation of the particles passing through the plasma, and quenching and condensation of the resultant high-temperature vapor.

The plasma process produces an argon plasma through arc discharge in an atmosphere of argon (inert gas), or a hydrogen, nitrogen, or oxygen plasma through arc discharge in an atmosphere of hydrogen, nitrogen, or oxygen (diatomic molecule gas). A hydrogen, nitrogen, or oxygen plasma is much more reactive than an inert gas plasma, and thus is called “reactive arc plasma” in distinction from the inert gas plasma.

The P-type semiconductor particles are preferably produced by an oxygen plasma process among reactive arc plasma processes.

The P-type semiconductor particles are preferably contained in an amount of 20 to 200 parts by mass, more preferably 50 to 150 parts by mass, relative to 100 parts by mass of the binder resin.

The P-type semiconductor particles contained in an amount of 20 parts by mass or more relative to 100 parts by mass of binder resin enable the protective layer to have a charge transporting function reliably. The P-type semiconductor particles contained in an amount of 200 parts by mass or less relative to 100 parts by mass of binder resin can ensure formation of a coating film for the protective layer.

### [Surface-Treated P-Type Semiconductor Particles]

The P-type semiconductor particles contained in the protective layer are preferably surface-treated with a surface treating agent, for improvement of dispersibility. The P-type semiconductor particles are more preferably surface-treated with a surface treating agent having a reactive organic group.

The surface treatment preferably uses a surface treating agent which reacts with, for example, a hydroxyl group present on the surfaces of untreated P-type semiconductor particles. Examples of such a surface treating agent include a silane coupling agent and a titanium coupling agent.

In the present invention, a surface treating agent having a reactive organic group is preferably used for further enhancing the hardness of the protective layer. The reactive organic group is more preferably a radically polymerizable reactive group. The surface treating agent having a radically polymerizable reactive group reacts with the below-described polymerizable compound, which is used for producing a cured resin serving as the binder resin for the protective layer. Thus, the surface treating agent enables formation of a strong protective film.

The surface treating agent having a radically polymerizable reactive group is preferably a silane coupling agent having an acryloyl group or a methacryloyl group. The surface treating agent having such a radically polymerizable reactive group is a known compound exemplified below.

Examples of the silane coupling agent having an acryloyl group or a methacryloyl group include compounds described below.
S-1: CH₂═CHSi(CH₃)(OCH₃)₂
S-2: CH₂═CHSi(OCH₃)₃
S-3: CH₂═CHSiCl₃
S-4: CH₂═CHCOO(CH₂)₂Si(CH₃)(OCH₃)₂
S-5: CH₂═CHCOO(CH₂)₂Si(OCH₃)₃
S-6: CH₂═CHCOO(CH₂)₂Si(OC₂H₅)(OCH₃)₂
S-7: CH₂═CHCOO(CH₂)₃Si(OCH₃)₃
S-8: CH₂═CHCOO(CH₂)₂Si(CH₃)Cl₂
S-9: CH₂═CHCOO(CH₂)₂SiCl₃
S-10: CH₂═CHCOO(CH₂)₃Si(CH₃)Cl₂
S-11: CH₂═CHCOO(CH₂)₃SiCl₃
S-12: CH₂═C(CH₃)COO(CH₂)₂Si(CH₃)(OCH₃)₂
S-13: CH₂═C(CH₃)COO(CH₂)₂Si(OCH₃)₃
S-14: CH₂═C(CH₃)COO(CH₂)₃Si(CH₃)(OCH₃)₂
S-15: CH₂═C(CH₃)COO(CH₂)₃Si(OCH₃)₃
S-16: CH₂═C(CH₃)COO(CH₂)₂Si(CH₃)Cl₂
S-17: CH₂═C(CH₃)COO(CH₂)₂SiCl₃
S-18: CH₂═C(CH₃)COO(CH₂)₃Si(CH₃)Cl₂
S-19: CH₂═C(CH₃)COO(CH₂)₃SiCl₃
S-20: CH₂═CHSi(C₂H₅)(OCH₃)₂
S-21: CH₂═C(CH₃)Si(OCH₃)₃
S-22: CH₂═C(CH₃)Si(OC₂H₅)₃
S-23: CH₂═CHSi(OCH₃)₃
S-24: CH₂═C(CH₃)Si(CH₃)(OCH₃)₂
S-25: CH₂═CHSi(CH₃)Cl₂
S-26: CH₂═CHCOOSi(OCH₃)₃
S-27: CH₂═CHCOOSi(OC₂H₅)₃
S-28: CH₂═C(CH₃)COOSi(OCH₃)₃
S-29: CH₂═C(CH₃)COOSi(OC₂H₅)₃
S-30: CH₂═C(CH₃)COO(CH₂)₃Si(OC₂H₅)₃
S-31: CH₂═CHCOO(CH₂)₂Si(CH₃)₂(OCH₃)
S-32: CH₂═CHCOO(CH₂)₂Si(CH₃)(OCOCH₃)₂
S-33: CH₂═CHCOO(CH₂)₂Si(CH₃)(ONHCH₃)₂
S-34: CH₂═CHCOO(CH₂)₂Si(CH₃)(OC₆H₅)₂
S-35: CH₂═CHCOO(CH₂)₂Si(C₁₀H₂₁)(OCH₃)₂
S-36: CH₂═CHCOO(CH₂)₂Si(CH₂C₆H₅)(OCH₃)₂

Alternatively, any surface treating agent other than these compounds S-1 to S-36 may be used, and the surface treating agent may be a silane compound having a reactive organic group capable of radical polymerization. These surface treating agents may be used alone or in combination.

The surface treating agent may be used in any amount. Preferably, the surface treating agent is used in an amount of 0.1 to 100 parts by mass relative to 100 parts by mass of untreated P-type semiconductor particles.

### [Surface Treatment Process for P-Type Semiconductor Particles]

Specifically, untreated P-type semiconductor particles can be surface-treated with the surface treating agent by wet crushing of a slurry (suspension of solid particles) containing the untreated P-type semiconductor particles and the surface treating agent, to form P-type semiconductor fine particles and to achieve surface treatment of the particles at the same time. The solvent is then removed, followed by powderization.

The slurry is preferably a mixture of 100 parts by mass of untreated P-type semiconductor particles, with 0.1 to 100 parts by mass of a surface treating agent and 50 to 5,000 parts by mass of a solvent.

The wet crushing of the solids in the slurry is performed with, for example, a wet-media disperser.

The wet-media disperser has a container loaded with media beads and a stirring disk mounted vertically to a rotary shaft. The stirring disk rapidly spins to mill and disperse agglomerated P-type semiconductor particles. Any type of disperser may be used which can sufficiently disperse the P-type semiconductor particles during the surface-treatment of the P-type semiconductor particles. Various types of the disperser may be used, such as a vertical type, a horizontal type, a continuous type, and a batch type. Specific examples of the disperser include a sand mill, an Ultravisco mill, a pearl mill, a grain mill, a Dyno mill, an agitator mill, and a dynamic mill. Such a disperser pulverizes and disperses particles by impact cracking, friction, shear force, or shear stress provided by grinding media, such as balls and beads.

The beads used in the wet-media disperser may be spheres formed of, for example, glass, alumina, zircon, zirconia, steel, or flint. The beads are particularly preferably formed of zirconia or zircon. Although the diameter of the beads is usually about 1 to 2 mm, a preferred diameter is about 0.1 to 1.0 mm in the present invention.

The disk and the inner wall of the container of the wet-media disperser may be formed of any material, such as stainless steel, nylon, or ceramic. In the present invention, the disk and the inner wall of the container is particularly preferably formed of a ceramic material, such as zirconia or silicon carbide.

[Cross-Linked Resin Particles 10eA]

The cross-linked resin particles are preferably formed of, for example, a silicone resin, a polycondensation product of melamine and formaldehyde, or a cross-linked polymer containing poly(methyl methacrylate).

The cross-linked resin particles may be surface-treated with a surface treating agent. A surface treating agent having a reactive organic group may be used for the surface treatment of the cross-linked resin particles.

The cross-linked resin particles preferably have a number average primary particle size of 0.1 to 1.0 μm, more preferably 0.2 to 0.5 μm.

The cross-linked resin particles having a number average primary particle size within such a range lead to formation of an appropriately rough surface of the photoreceptor, to achieve sufficient cleaning operations.

The number average primary particle size of the cross-linked resin particles is determined as in the P-type semiconductor particles.

In the present invention, the ratio A/B of the number average primary particle size A of the cross-linked resin particles to the number average primary particle size B of the P-type semiconductor particles preferably satisfies a relation: 2≦A/B≦10, more preferably 5≦A/B≦10.

As illustrated in FIG. 4A, a ratio A/B of 2 or more leads to a larger number of insulating cross-linked resin particles exposed on the surface of the protective layer, as compared with the case of a ratio A/B of 1 shown in FIG. 4B. This can reduce discharge-receiving points relatively, to further reduce the number of electrons passing through the protective layer.

The cross-linked resin particles are preferably contained in an amount of 10 to 100 parts by mass, more preferably 20 to 50 parts by mass, relative to 100 parts by mass of the binder resin.

The cross-linked resin particles contained in an amount of 10 parts by mass or more relative to 100 parts by mass of binder resin can be reliably exposed on the surface of the protective layer. The cross-linked resin particles contained in an amount of 100 parts by mass or less relative to 100 parts by mass of binder resin can ensure formation of a coating film for the protective layer.

### [Binder Resin for Protective Layer]

The binder resin for the protective layer is preferably a thermoplastic resin or a photocurable resin. In particular, the binder resin is more preferably a photocurable resin, which provides the protective layer with high strength.

Examples of the binder resin for the protective layer include polyvinyl butyral resins, epoxy resins, polyurethane resins, phenolic resins, polyester resins, alkyd resins, polycarbonate resins, silicone resins, acrylic resins, and melamine resins. The thermoplastic resins are preferably polycarbonate resins. The photocurable resin is prepared from a compound having two or more radically polymerizable functional groups (hereinafter also referred to as “polyfunctional radically polymerizable compound”). The cured resin is preferably produced through polymerization of a polyfunctional radically polymerizable compound by irradiation with actinic rays, such as UV rays or electron beams.

The aforementioned binder resins for the protective layer may be used alone or in combination.

### [Polyfunctional Radically Polymerizable Compound]

Examples of the particularly preferred polyfunctional radically polymerizable compounds include acrylic monomers having two or more acryloyl groups (CH₂═CHCO—) or methacryloyl groups (CH₂═CCH₃CO—), which are radically polymerizable functional groups, and oligomers derived from the monomers. These monomers and oligomers can be cured with a small amount of light or within a short period of time. Thus, the cured resin is preferably an acrylic resin formed of an acrylic monomer or an oligomer derived therefrom.

Examples of the polyfunctional radically polymerizable compound include compounds described below.

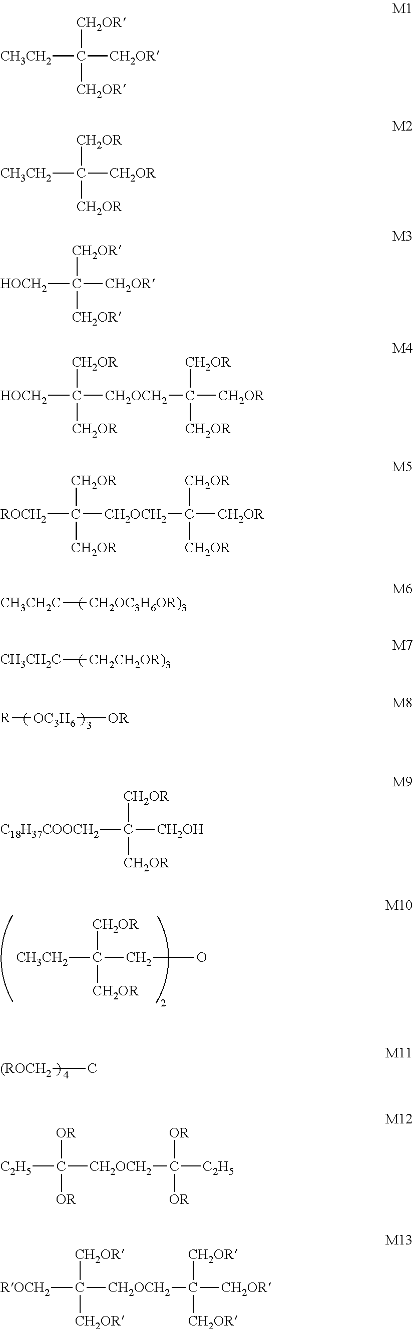

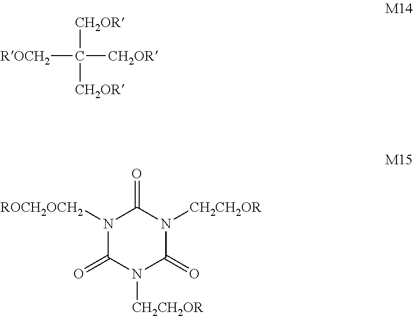

In the chemical formulae representing the exemplary compounds M1 to M15, R is an acryloyl group (CH₂═CHCO—), and R′ is a methacryloyl group (CH₂═CCH₃CO—).

The protective layer may optionally contain a charge transporting material, a polymerization initiator, or lubricant particles, in addition to the aforementioned binder resin, P-type semiconductor particles, and cross-linked resin particles.

### [Charge Transporting Material]

The charge transporting material which can be incorporated into the protective layer may optionally have a reactive group that reacts with the reactive organic group of the surface treating agent used for the surface treatment, during formation of the protective layer, of the cross-linked resin particles, the P-type semiconductor particles, or the polyfunctional radically polymerizable compound for forming the protective layer.

The charge transporting material can transport charge carriers in the protective layer. The charge transporting material absorbs substantially no light in an ultraviolet region, and generally has a molecular weight of 450 or less (preferably 320 to 420). The charge transporting material can enter pores of the binder resin forming the protective layer. Thus, the charge transporting material can smoothly transport charge carriers from the charge transporting sublayer to the surface of the protective layer without causing impairment of the wear resistance of the protective layer.

### [Polymerization Initiator]

The polymerization initiator which can be incorporated into the protective layer is a radical polymerization initiator for initiating polymerization of the polyfunctional radically polymerizable compound, for example, a thermal polymerization initiator or a photopolymerization initiator.

The polyfunctional radically polymerizable compound can be polymerized through, for example, electron-beam cleavage, or application of light or heat in the presence of the radical polymerization initiator.

Examples of the thermal polymerization initiator include azo compounds, such as 2,2′-azobisisobutyronitrile, 2,2′-azobis(2,4-dimethylazobisvaleronitrile), and 2,2′-azobis(2-methylbutyronitrile); and peroxides, such as benzoyl peroxide (BPO), di-tert-butyl hydroperoxide, tert-butyl hydroperoxide, chlorobenzoyl peroxide, dichlorobenzoyl peroxide, bromomethylbenzoyl peroxide, and lauroyl peroxide.

Examples of the photopolymerization initiator include acetophenone and ketal initiators, such as diethoxyacetophenone, 2,2-dimethoxy-1,2-diphenylethan-1-one, 1-hydroxy-cyclohexyl-phenyl-ketone, 4-(2-hydroxyethoxy)phenyl-(2-hydroxy-2-propyl)ketone, 2-benzyl-2-dimethylamino-1-(4-morpholinophenyl)butanone-1 (“Irgacure 369,” manufactured by BASF Japan Ltd.), 2-hydroxy-2-methyl-1-phenylpropan-1-one, 2-methyl-2-morpholino(4-methylthiophenyl)propan-1-one, and 1-phenyl-1,2-propanedione-2-(o-ethoxycarbonyl)oxime; benzoin ether initiators, such as benzoin, benzoin methyl ether, benzoin ethyl ether, benzoin isobutyl ether, and benzoin isopropyl ether; benzophenone initiators, such as benzophenone, 4-hydroxybenzophenone, o-benzoyl methyl benzoate, 2-benzoylnaphthalene, 4-benzoylbiphenyl, 4-benzoyl phenyl ether, acrylated benzophenone, and 1,4-benzoylbenzene; and thioxanthone initiators, such as 2-isopropylthioxanthone, 2-chlorothioxanthone, 2,4-dimethylthioxanthone, 2,4-diethylthioxanthone, and 2,4-dichlorothioxanthone.

Other photopolymerization initiators include ethylanthraquinone, 2,4,6-trimethylbenzoyldiphenylphosphine oxide, 2,4,6-trimethylbenzoylphenylethoxyphosphine oxide, bis(2,4,6-trimethylbenzoyl)phenylphosphine oxide (“Irgacure 819,” manufactured by BASF Japan Ltd.), bis(2,4-dimethoxybenzoyl)-2,4,4-trimethylpentylphosphine oxide, methylphenylglyoxyester, 9,10-phenanthrene, acridine compounds, triazine compounds, and imidazole compounds. A compound having a photopolymerization promoting effect may be used alone or in combination with any of the aforementioned photopolymerization initiators. Examples of the compound having a photopolymerization promoting effect include triethanolamine, methyldiethanolamine, 4-dimethylaminoethyl benzoate, 4-dimethylaminoisoamyl benzoate, (2-dimethylamino)ethyl benzoate, and 4,4′-dimethylaminobenzophenone.

The polymerization initiator is preferably a photopolymerization initiator, more preferably an alkylphenone compound or a phosphine oxide compound, still more preferably a photopolymerization initiator having an α-hydroxyacetophenone structure or an acylphosphine oxide structure.

These polymerization initiators may be used alone or in combination.

The polymerization initiator is usually used in an amount of 0.1 to 40 parts by mass, preferably 0.5 to 20 parts by mass, relative to 100 parts by mass of the polyfunctional radically polymerizable compound.

### [Lubricant Particles]

The lubricant particles may be, for example, fluorine-containing resin particles. Examples of the fluorine-containing resin include tetrafluoroethylene resins, trifluorochloroethylene resins, hexafluorochloroethylene-propylene resins, vinyl fluoride resins, vinylidene fluoride resins, and difluorodichloroethylene resins. These copolymers may be used alone or in combination. Of these, particularly preferred are tetrafluoroethylene and vinylidene fluoride resins.

The protective layer preferably has a thickness of 0.2 to 10 μm, more preferably 0.5 to 6 μm.

### [Formation of Protective Layer]

The protective layer is formed through the following process. A coating liquid is prepared by adding, to a solvent, the polyfunctional radically polymerizable compound, the P-type semiconductor particles, the cross-linked resin particles, and optional components, such as a known resin, polymerization initiator, lubricant particles, and antioxidant. The coating liquid is applied onto the surface of the photosensitive layer by a known process, to form a coating film, followed by curing of the coating film.

### [Solvent]

Examples of the solvent used for formation of the protective layer include, but are not limited to, methanol, ethanol, 1-propanol, 2-propanol, 1-butanol, 2-butanol, 2-methyl-2-propanol, benzyl alcohol, methyl isopropyl ketone, methyl isobutyl ketone, methyl ethyl ketone, cyclohexane, toluene, xylene, methylene chloride, ethyl acetate, butyl acetate, 2-methoxyethanol, 2-ethoxyethanol, tetrahydrofuran, 1-dioxane, 1,3-dioxolane, pyridine, and diethylamine.

These solvents may be used alone or in combination.

The coating film is preferably irradiated with actinic rays to generate radicals that initiate polymerization and intermolecular and intramolecular cross-linking reactions, to cure the binder resin. The actinic rays are preferably UV rays, visible light, or electron beams. UV rays, which are easy to use, are particularly preferred.

Examples of the UV source include low-pressure mercury lamps, middle-pressure mercury lamps, high-pressure mercury lamps, ultrahigh-pressure mercury lamps, carbon-arc lamps, metal halide lamps, xenon lamps, flash (pulsed) xenon lamps, and UV LEDs. The conditions of emitting actinic rays may vary depending on the type of the lamp. The intensity of emission is generally 1 to 20 mJ/cm², preferably 5 to 15 mJ/cm². The output power of the light source is in the range of preferably 0.1 to 5 kW, particularly preferably 0.5 to 3 kW.

The electron beam source is preferably, for example, a curtain beam-type electron beam emitting device. The accelerating voltage during emission of electron beams is in the range of preferably 100 to 300 kV. The absorbed dose is in the range of preferably 0.005 Gy to 100 kGy (0.5 to 10 Mrad).

The time for emission of actinic rays may be determined in accordance with a necessary amount of actinic rays. The emission time is in the range of preferably 0.1 second to 10 minutes, more preferably 1 second to 5 minutes, from the viewpoint of curing or operational efficiency.

The coating film may be dried before, during, or after emission of actinic rays. The timing of drying may be appropriately determined in combination with the actinic ray emission conditions. The drying conditions for the protective layer may be appropriately determined depending on the type of the solvent used for the coating liquid or the thickness of the protective layer. The drying temperature is in the range of preferably room temperature to 180° C., particularly preferably 80 to 140° C. The drying period is in the range of preferably 1 to 200 minutes, particularly preferably 5 to 100 minutes. Drying of the coating film under these conditions can control the amount of the solvent contained in the protective layer to 20 ppm to 75 ppm.

The components other than the protective layer of the photoreceptor having the layer configuration (1) will now be described.

### [Conductive Support 10a]

Any conductive support can be used in the present invention. Examples of the conductive support include drums and sheets composed of metals, such as aluminum, copper, chromium, nickel, zinc, and stainless steel; plastic films laminated with metal foil of aluminum or copper; plastic films provided with deposited layers of aluminum, indium oxide, or tin oxide; and metal and plastic films and paper sheets having conductive layers formed through application of a conductive substance alone or in combination with a binder resin.

### [Intermediate Layer 10b]

The intermediate layer functions as a barrier and an adhesive between the conductive support and the organic photosensitive layer. The intermediate layer is preferably provided for preventing various failures.

The intermediate layer contains, for example, a binder resin and optional conductive particles or metal oxide particles.

Examples of the binder resin include casein, polyvinyl alcohol, nitrocellulose, ethylene-acrylic acid copolymers, polyamide resins, polyurethane resins, and gelatin. Among these resins, preferred are alcohol-soluble polyamide resins.

The intermediate layer may contain any conductive particulate or metal oxide particulate for controlling the resistance. Examples thereof include particles of metal oxides, such as alumina, zinc oxide, titanium oxide, tin oxide, antimony oxide, indium oxide, and bismuth oxide. Alternatively, the intermediate layer may contain ultrafine particles, such as particles of tin-doped indium oxide, antimony-doped tin oxide, and antimony-doped zirconium oxide.

Such metal oxide particles preferably have a number average primary particle size of 0.3 μm or less, more preferably 0.1 μm or less.

These particulate metal oxides may be used alone or in combination. A mixture of two or more particulate metal oxides may be in the form of solid solution or fusion.

The conductive particles or the metal oxide particles are preferably contained in an amount of 20 to 400 parts by mass, more preferably 50 to 200 parts by mass, relative to 100 parts by mass of the binder resin.

The intermediate layer is formed through, for example, the following process. A coating liquid for the intermediate layer is prepared by dissolving the binder resin in a known solvent, and optionally dispersing the conductive particles or the metal oxide particles in the solution. The coating liquid for the intermediate layer is applied onto the surface of the conductive support, to form a coating film, followed by drying of the coating film.

Examples of the solvent used for formation of the intermediate layer include, but are not limited to, n-butylamine, diethylamine, ethylenediamine, isopropanolamine, triethanolamine, triethylenediamine, N,N-dimethylformamide, acetone, methyl ethyl ketone, methyl isopropyl ketone, cyclohexanone, benzene, toluene, xylene, chloroform, dichloromethane, 1,2-dichloroethane, 1,2-dichloropropane, 1,1,2-trichloroethane, 1,1,1-trichloroethane, trichloroethylene, tetrachloroethane, tetrahydrofuran, dioxolane, dioxane, methanol, ethanol, butanol, 2-propanol, ethyl acetate, butyl acetate, dimethyl sulfoxide, and methyl cellosolve. Of these, preferred are toluene, tetrahydrofuran, and dioxolane. These solvents may be used alone or in combination.

The conductive particles or the metal oxide particles may be dispersed with any device, such as an ultrasonic disperser, a ball mill, a sand grinder, or a homomixer.

The coating liquid for the intermediate layer may be applied through any technique, such as dip coating or spray coating.

The coating film may be dried through any known technique appropriately determined depending on the type of the solvent or the thickness of the intermediate layer. Thermal drying is particularly preferred.

The intermediate layer preferably has a thickness of 0.1 to 15 μm, more preferably 0.3 to 10 μm.

### [Charge Generating Sublayer 10c]

The charge generating sublayer contains a charge generating material and a binder resin (hereinafter also referred to as “binder resin for the charge generating sublayer”).

Examples of the charge generating material include, but are not limited to, azo pigments, such as Sudan Red and Diane Blue; quinone pigments, such as pyrenequinone and anthanthrone; quinocyanine pigments; perylene pigments; indigo pigments, such as indigo and thioindigo; polycyclic quinone pigments, such as pyranthrone and diphthaloylpyrene; and phthalocyanine pigments. Among these materials, preferred are polycyclic quinone pigments and titanylphthalocyanine pigments. These charge generating materials may be used alone or in combination.

Examples of the binder resin for the charge generating sublayer include, but are not limited to, known resins, such as polystyrene resins, polyethylene resins, polypropylene resins, acrylic resins, methacrylic resins, vinyl chloride resins, vinyl acetate resins, polyvinyl butyral resins, epoxy resins, polyurethane resins, phenolic resins, polyester resins, alkyd resins, polycarbonate resins, silicone resins, melamine resins, copolymer resins containing two or more of these resins (e.g., vinyl chloride-vinyl acetate copolymer resins and vinyl chloride-vinyl acetate-maleic anhydride copolymer resins), and polyvinylcarbazole resins. Among these resins, preferred are polyvinyl butyral resins.

The charge generating material is preferably contained in the charge generating sublayer in an amount of 1 to 600 parts by mass, more preferably 50 to 500 parts by mass, relative to 100 parts by mass of the binder resin for the charge generating sublayer.

The charge generating material is preferably mixed with the binder resin in an amount of 20 to 600 parts by mass, more preferably 50 to 500 parts by mass, relative to 100 parts by mass of the binder resin. Mixing of the binder resin and the charge generating material in the aforementioned proportions achieves high dispersion stability in the below-described coating liquid for the charge generating sublayer, and reduces the electrical resistance of the photoreceptor and also prevents an increase in residual potential during repeated use.

The charge generating sublayer is formed through, for example, the following process. A coating liquid for the charge generating sublayer is prepared by dispersing the charge generating material in the binder resin dissolved in a known solvent. The coating liquid for the charge generating sublayer is applied onto the surface of the intermediate layer, to form a coating film, followed by drying of the coating film.

Formation of the charge generating sublayer may use any solvent which can dissolve the binder resin for the charge generating sublayer. Examples of the solvent include, but are not limited to, ketone solvents, such as methyl ethyl ketone, methyl isopropyl ketone, methyl isobutyl ketone, cyclohexanone, and acetophenone; ether solvents, such as tetrahydrofuran, dioxolane, and diglyme; alcohol solvents, such as methyl cellosolve, ethyl cellosolve, and butanol; ester solvents, such as ethyl acetate and t-butyl acetate; aromatic solvents, such as toluene and chlorobenzene; and halogenated solvents, such as dichloroethane and trichloroethane. These solvents may be used alone or in combination.

The charge generating material may be dispersed by the same means as used for dispersing the conductive particles or the metal oxide particles in the coating liquid for the intermediate layer.

The coating liquid for the charge generating sublayer may be applied in the same manner as that for the coating liquid for the intermediate layer.

The thickness of the charge generating sublayer may vary depending on the properties of the charge generating material, the properties of the binder resin for the charge generating sublayer, or the amount of the binder resin contained in the sublayer. The thickness is in the range of preferably 0.1 to 2 μm, more preferably 0.15 to 1.5 μm.

### [Charge Transporting Sublayer 10d]

The charge transporting sublayer contains a charge transporting material and a binder resin (hereinafter also referred to as “binder resin for the charge transporting sublayer”).

Examples of the charge transporting material for the charge transporting sublayer include triphenylamine derivatives, hydrazone compounds, styryl compounds, benzidine compounds, and butadiene compounds.

Examples of the binder resin for the charge transporting sublayer include known resins, such as polycarbonate resins, polyacrylate resins, polyester resins, polystyrene resins, styrene-acrylonitrile copolymer resins, polymethacrylic acid ester resins, and styrene-methacrylic acid ester copolymer resins. Polycarbonate resins are preferably used. Polycarbonate resins, such as Bisphenol A (BPA), Bisphenol Z (BPZ), dimethyl BPA, and BPA-dimethyl BPA copolymer, are more preferred, from the viewpoints of cracking resistance, wear resistance, and charging characteristics.

The charge transporting material is preferably contained in the charge transporting sublayer in an amount of 10 to 500 parts by mass, more preferably 20 to 250 parts by mass, relative to 100 parts by mass of the binder resin for the charge transporting sublayer.

The charge transporting sublayer may contain an antioxidant, an electron conductor, a stabilizer, or silicone oil. Preferred antioxidants are disclosed in Japanese Unexamined Patent Application Publication No. 2000-305291, and preferred electron conductors are disclosed in, for example, Japanese Unexamined Patent Application Publication Nos. S50-137543 and S58-76483.

The thickness of the charge transporting sublayer may vary depending on the properties of the charge transporting material, the properties of the binder resin for the charge transporting sublayer, or the amount of the binder resin contained in the sublayer. The thickness is in the range of preferably 5 to 40 μm, more preferably 10 to 30 μm.

The charge transporting sublayer is formed through, for example, the following process. A coating liquid for the charge transporting sublayer is prepared by dispersing the charge transporting material (CTM) in the binder resin dissolved in a known solvent. The coating liquid for the charge transporting sublayer is applied onto the surface of the charge generating sublayer, to form a coating film, followed by drying of the coating film.

The solvent used for formation of the charge transporting sublayer may be the same as that used for formation of the charge generating sublayer.

The coating liquid for the charge transporting sublayer may be applied in the same manner as that for the coating liquid for the charge generating sublayer.

### [Charging Roller]

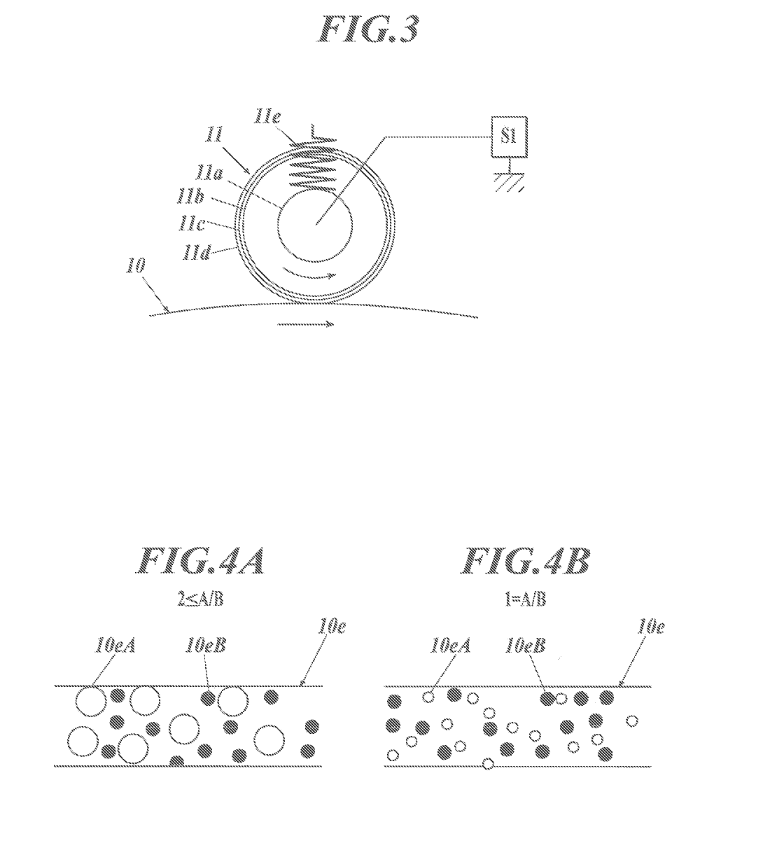

The charging roller 11, which is the proximity-type charging unit, negatively charges the surface of the photoreceptor. As illustrated in FIG. 3, the charging roller 11 includes a core 11a, an elastic layer 11b, a resistance controlling layer 11c, and a surface layer 11d disposed in sequence. The elastic layer 11b reduces charging noise and enables the roller 11 to come in uniform contact with the photoreceptor 10. The resistance controlling layer 11c, which is optionally provided, enables the entire charging roller 11 to have highly uniform electrical resistance. The charging roller 11 is biased toward the photoreceptor 10 by a pressure spring 11e and comes into contact with the surface of the photoreceptor 10 at a specific pressure, to form a charging nip. The charging roller 11 rotates in association with rotation of the photoreceptor 10.

The core 11a is composed of a metal, such as iron, copper, stainless steel, aluminum, or nickel. The metal may be plated for achieving corrosion resistance or scratch resistance to such an extent that conductivity is maintained. The core 11a has an outer diameter of, for example, 3 to 20 mm.

The elastic layer 11b is composed of an elastic material, such as rubber, containing fine particles of a conductive substance, such as carbon black or carbon graphite, or fine particles of a conductive salt, such as an alkali metal or ammonium salt. Specific examples of the elastic material include natural rubber; synthetic rubbers, such as ethylene-propylene-diene-monomer (EPDM) rubbers, styrene-butadiene rubbers (SBRs), silicone rubbers, urethane rubbers, epichlorohydrin rubbers, isoprene rubbers (IRs), butadiene rubbers (BRs), nitrile-butadiene rubbers (NBR), and chloroprene rubbers (CR); resins, such as polyamide resins, polyurethane resins, silicone resins, and fluororesins; and foamed products, such as sponge. The elasticity of the elastic material can be adjusted by addition of, for example, a process oil or a plasticizer thereto.

The elastic layer 11b preferably has a volume resistivity of 1×10¹ to 1×10¹⁰ Ω·cm. The elastic layer 11b preferably has a thickness of 500 to 5,000 μm, more preferably 500 to 3,000 μm.

The volume resistivity of the elastic layer 11b is determined in accordance with JIS K 6911.

The resistance controlling layer 11c is formed for, for example, providing the entire charging roller 11 with uniform electrical resistance. Alternatively, the resistance controlling layer 11c may be omitted. The resistance controlling layer 11c can be formed through coating of the elastic layer 11b with a material having appropriate conductivity, or covering of the layer 11b with a tube having appropriate conductivity.

The material for the resistance controlling layer 11c is specifically prepared by adding a conductive agent to a base material. Examples of the base material include resins, such as polyamide resins, polyurethane resins, fluororesins, and silicone resins; and rubbers, such as epichlorohydrin rubbers, urethane rubbers, chloroprene rubbers, and acrylonitrile rubbers. Examples of the conductive agent include fine particles of conductive substances, such as carbon black and carbon graphite; fine particles of conductive metal oxides, such as conductive titanium oxide, zinc oxide, and tin oxide; and fine particles of conductive salts, such as alkali metal salts and ammonium salts.

The resistance controlling layer 11c preferably has a volume resistivity of 1×10⁻² to 1×10¹⁴ Ω·cm, more preferably 1×10¹ to 1×10¹⁰ Ω·cm. The resistance controlling layer 11c preferably has a thickness of 0.5 to 100 μm, more preferably 1 to 50 μm, still more preferably 1 to 20 μm.

The volume resistivity of the resistance controlling layer 11c is determined in accordance with JIS K 6911.

The surface layer 11d is formed for, for example, preventing a plasticizer contained in the elastic layer 11b from bleeding on the surface of the charging roller, providing the surface of the charging roller with smoothness, or preventing occurrence of leakage even with defects, such as pinholes, on the photoreceptor 10. The surface layer 11d is formed through coating of the resistance controlling layer 11c with a material having appropriate conductivity, or covering of the layer 11c with a tube having appropriate conductivity.

The material used for formation of the surface layer 11d through the coating process is specifically prepared by adding a conductive agent to a base material. Examples of the base material include resins, such as polyamide resins, polyurethane resins, acrylic resins, fluororesins, and silicone resins; and rubbers, such as epichlorohydrin rubbers, urethane rubbers, chloroprene rubbers, and acrylonitrile rubbers. Examples of the conductive agent include fine particles of conductive substances, such as carbon black and carbon graphite; and fine particles of conductive metal oxides, such as conductive titanium oxide, zinc oxide, and tin oxide. Examples of the coating technique include dip coating, roll coating, and spray coating.

The tube used for formation of the surface layer 11d through the covering process is specifically a tube formed from a thermoplastic elastomer containing the aforementioned conductive agent. Examples of the thermoplastic elastomer include nylon 12, tetrafluoroethylene-perfluoroalkyl vinyl ether copolymer resins (PFA), polyvinylidene fluoride, tetrafluoroethylene-hexafluoropropylene copolymer (FEP) resins, polystyrene, polyolefins, polyvinyl chloride, polyurethanes, polyesters, and polyamides. The tube may be shrinkable or unshrinkable by heat.

The surface layer 11d preferably has a volume resistivity of 1×10¹ to 1×10⁸ Ω·cm, more preferably 1×10¹ to 1×10⁵ Ω·cm. The surface layer 11d preferably has a thickness of 0.5 to 100 μm, more preferably 1 to 50 μm, still more preferably 1 to 20 μm.

The volume resistivity of the surface layer 11d is determined in accordance with JIS K 6911.

The surface layer 11d preferably has a surface roughness Rz of 1 to 30 μm, more preferably 2 to 20 μm, still more preferably 5 to 10 μm.

The surface of the photoreceptor 10 is maintained at a predetermined potential with a specific polarity through application of a charging bias voltage from a power supply S1 to the core 11a of the charging roller 11. The charging bias voltage may be, for example, a plain DC voltage. The charging bias voltage is preferably an oscillation voltage including an AC voltage superimposed on a DC voltage for achieving highly uniform charging.

The charging bias voltage is in the range of, for example, about −2.5 to −1.5 kV.

The photoreceptor 10 is charged from the charging roller illustrated in FIG. 3 through, for example, application of a charging bias voltage including a DC voltage (Vdc) of −500 V and a sinusoidal AC voltage (Vac) with a frequency of 1,000 Hz and a peak-to-peak voltage of 1,300 V. The surface of the photoreceptor 10 is uniformly charged to −500 V through application of the charging bias voltage.

The charging roller 11 has a length based on the longitudinal length of the photoreceptor 10. The longitudinal length may be, for example, 320 mm.

In the image forming apparatus, while the photoreceptor 10 is rotated, the surface of the photoreceptor 10 is uniformly charged to a specific potential by the charging roller 11 to which a charging bias voltage is applied from the power supply S1.

The uniformly charged photoreceptor 10 is then exposed by the exposing unit 12 to form an electrostatic latent image. The electrostatic latent image is developed with the developing unit 13 to form a toner image. The toner image formed on the photoreceptor 10 is transferred with the transferring unit 14 onto the transfer medium P conveyed at a matched timing. The toner image is separated from the photoreceptor 10 by a separating unit (not illustrated) and fixed with the fixing unit 17, to form a visible image.

The residual toner on the photoreceptor 10 is removed with the cleaning blade 18a of the cleaning unit 18, and the removed toner is stored in a reservoir 18b.

The image forming apparatus according to the present invention is not limited to the configuration described above. For example, the image forming apparatus may be applied to a color image forming apparatus including a plurality of image forming units each including a photoreceptor arranged along an intermediate transferring member.

In a preferred embodiment, all the photoreceptors of the image forming units in the color image forming apparatus have the aforementioned layer configuration. Alternatively, at least one photoreceptor may have the layer configuration. This layer configuration enables the photoreceptor to exhibit high wear resistance even after negative charging with a proximity-type charging unit, and achieves formation of an image of high stability.

### [Image Forming Method]

The image forming method according to the present invention is a method to form an image using an image forming apparatus including an electrophotographic photoreceptor according to the present invention. The electrophotographic photoreceptor includes a conductive support, a photosensitive layer formed over the conductive support, and a protective layer formed over the photosensitive layer. The protective layer of the electrophotographic photoreceptor contains a binder resin, a particulate P-type semiconductor, and a particulate cross-linked resin composed of an insulating cross-linked polymer.

### [Toner and Developer]

The image forming apparatus according to the invention uses a negatively chargeable toner. The image forming apparatus may use a ground toner or a polymerized toner. The image forming apparatus preferably uses a polymerized toner, which is produced through a polymerization process, from the viewpoint of formation of a high-quality image.

As used herein, the term “polymerized toner” refers to a toner obtained by producing a binder resin for forming the toner in parallel with forming the shape of the toner particles through polymerization of a raw material monomer for the binder resin and a subsequent optional chemical treatment.

More specifically, the polymerized toner is produced through a step of forming resin fine particles through polymerization reaction, such as suspension polymerization or emulsion polymerization, and a subsequent optional step of fusing the resin fine particles together.

The toner preferably has a volume average particle size (i.e., 50% volume particle size, Dv50) of 2 to 9 μm, more preferably 3 to 7 μm. The toner having a particle size within such a range leads to high resolution. In addition, the toner having the aforementioned small particle size, which contains a small number of fine toner particles, can achieve high reproducibility of dot images over a long period of time, and enables formation of a sharp and stable image.

In the present invention, the toner may be used alone as a one-component developer, or may be mixed with a carrier to form a two-component developer.

The toner may be used as a non-magnetic one-component developer, or a magnetic one-component developer containing magnetic particles having a size of about 0.1 to 0.5 μm. The carrier mixed with the toner to form a two-component developer may be magnetic particles formed of a conventionally known material; for example, a metal, such as iron, ferrite, or magnetite, or an alloy of such a metal with aluminum or lead. Ferrite particles are particularly preferred. The magnetic particles preferably have a volume average particle size of 15 to 100 μm, more preferably 25 to 80 μm.

The volume average particle size of the carrier can be typically determined with a laser diffraction particle size analyzer (“HELOS,” manufactured by SYMPATEC) equipped with a wet disperser.

The carrier is preferably formed of magnetic particles coated with a resin, or magnetic particles dispersed in a resin. Examples of the resin for coating include, but are not limited to, olefin resins, styrene resins, styrene-acrylic resins, silicone resins, ester resins, and fluorine-containing polymer resins. Examples of the resin for dispersing magnetic particles therein include, but are not limited to, known resins, such as styrene-acrylic resins, polyester resins, fluororesins, and phenolic resins.

Although the present invention has been described in detail with reference to the embodiment, the invention is not limited to the embodiment, and various modifications may be made.

### EXAMPLES

The present invention will now be described in detail by way of examples, which should not be construed as limiting the invention thereto.

### Preparation Example 1 of P-Type Semiconductor Particle: CuAlO₂

Al₂O₃ (purity: 99.9%) and Cu₂O (purity: 99.9%) were mixed in a molar ratio of 1:1, and the mixture was calcined in an Ar atmosphere at 1,100° C. for four days. The calcined product was pelletized and sintered at 1,100° C. for two days. The sintered product was then coarsely pulverized into particles having a size of several hundred micrometers. The resultant coarse particles were then mixed with a solvent, and the mixture was subjected to wet pulverization with a wet-media disperser, to produce untreated CuAlO₂ particles having a number average primary particle size of 0.05 μm.

The untreated CuAlO₂ particles (100 parts by mass), a surface treating agent “KBM-503” (30 parts by mass), and methyl ethyl ketone (1,000 parts by mass) were placed into a wet sand mill (containing alumina beads having a size of 0.5 mm), and then mixed at 30° C. for six hours. After methyl ethyl ketone and alumina beads were separated through filtration, the residue was dried at 60° C., to produce surface-treated CuAlO₂ particles, which will be called “P-type semiconductor particles [1].”

### Preparation Example 2 of P-Type Semiconductor Particle: CuAlO₂

Untreated CuAlO₂ particles were produced in the same manner as in Preparation Example 1 of P-type Semiconductor Particle, except that the pulverization conditions in the wet-media disperser were modified to achieve a number average primary particle size of 0.1 μm of the untreated CuAlO₂ particles. The untreated CuAlO₂ particles were surface-treated as in Preparation Example 1 of P-type Semiconductor Particle, to produce surface-treated CuAlO₂ particles, which will be called “P-type semiconductor particles [2].”

### Preparation Example 3 of P-Type Semiconductor Particle: CuAlO₂

Untreated CuAlO₂ particles were produced in the same manner as in Preparation Example 1 of P-type Semiconductor Particle, except that the pulverization conditions in the wet-media disperser were modified to achieve a number average primary particle size of 0.2 μm of the untreated CuAlO₂ particles. The untreated CuAlO₂ particles were surface-treated as in Preparation Example 1 of P-type Semiconductor Particle, to produce surface-treated CuAlO₂ particles, which will be called “P-type semiconductor particles [3].”

### Preparation Example 4 of P-Type Semiconductor Particle: CuInO₂

In₂O₃ (purity: 99.9%) and Cu₂O (purity: 99.9%) were mixed in a molar ratio of 1:1, and the mixture was calcined in an Ar atmosphere at 1,100° C. for four days. The calcined product was pelletized and sintered at 1,100° C. for two days. The sintered product was then coarsely pulverized into particles having a size of several hundred micrometers. The resultant coarse particles were then mixed with a solvent, and the mixture was subjected to wet pulverization with a wet-media disperser, to produce untreated CuInO₂ particles having a number average primary particle size of 0.1 μm.

The untreated CuInO₂ particles (100 parts by mass), a surface treating agent “KBM-503” (30 parts by mass), and methyl ethyl ketone (1,000 parts by mass) were placed into a wet sand mill (containing alumina beads having a size of 0.5 mm), and then mixed at 30° C. for six hours. After methyl ethyl ketone and alumina beads were separated through filtration, the residue was dried at 60° C., to produce surface-treated CuInO₂ particles, which will be called “P-type semiconductor particles [4].”

### Preparation Example 5 of P-Type Semiconductor Particle: CuInO₂

Untreated CuInO₂ particles were produced in the same manner as in Preparation Example 4 of P-type Semiconductor Particle, except that the pulverization conditions in the wet-media disperser were modified to achieve a number average primary particle size of 0.02 μm of the untreated CuInO₂ particles. The untreated CuInO₂ particles were surface-treated as in Preparation Example 4 of P-type Semiconductor Particle, to produce surface-treated CuInO₂ particles, which will be called “P-type semiconductor particles [5].”

### Preparation Example 1 of Photoreceptor

### (1) Preparation of Conductive Support

A conductive support [1] having a surface roughness Rz of 1.5 μm was prepared through milling of the surface of a cylindrical aluminum support (outer diameter: 30 mm, length: 360 mm).

### (2) Formation of Intermediate Layer

A coating liquid [1] for an intermediate layer was prepared through dispersion of the following raw materials with a sand mill by a batch process for 10 hours.

| | | |
|---|---|---|
| Binder resin: polyamide resin “X1010” | 1 | part by mass |
| (manufactured by Daicel Degussa Ltd.) | | |
| Solvent: ethanol | 20 | parts by mass |
| Metal oxide fine particles: titanium oxide fine | 1.1 | parts by mass |
| particles having a number average primary particle | | |
| size of 0.035 μm “SMT500SAS” | | |
| (manufactured by TAYCA Corporation) | | |

The coating liquid [1] for an intermediate layer was applied onto the conductive support [1] through dip coating, to form a coating film. The coating film was dried at 110° C. for 20 minutes, to form an intermediate layer [1] having a thickness of 2 μm.

### (3) Formation of Charge Generating Sublayer

A coating liquid [1] for a charge generating sublayer was prepared through dispersion of the following raw materials with a sand mill for 10 hours.

| | | |
|---|---|---|
| Charge generating material: titanylphthalocyanine | 20 | parts by mass |
| pigment (having at least a maximum diffraction | | |
| peak at 27.3° as measured by Cu-Kα X-ray | | |
| diffractometry) | | |
| Binder resin: polyvinyl butyral resin “#6000-C” | 10 | parts by mass |
| (manufactured by DENKI KAGAKU KOGYO | | |
| KABUSHIKI KAISHA) | | |
| Solvent: t-butyl acetate | 700 | parts by mass |
| Solvent: 4-methoxy-4-methyl-2-pentanone | 300 | parts by mass |

The coating liquid [1] for a charge generating sublayer was applied onto the intermediate layer [1] through dip coating, to form a coating film. Thus, a charge generating sublayer [1] having a thickness of 0.3 μm was formed.

### (4) Formation of Charge Transporting Sublayer

A coating liquid [1] for a charge transporting sublayer was prepared through mixing of the following raw materials.

| | | |
|---|---|---|
| Charge transporting material: compound | 150 | parts by mass |
| represented by Formula (A) | | |
| Binder resin: polycarbonate resin “Z300” | 300 | parts by mass |
| (manufactured by Mitsubishi Gas Chemical | | |
| Company, Inc.) | | |
| Solvent: toluene/tetrahydrofuran (1/9 by volume) | 2,000 | parts by mass |
| Antioxidant: “Irganox 1010” (manufactured | 6 | parts by mass |
| by Nihon Ciba-Geigy K.K.) | | |
| Leveling agent: silicone oil “KF-54” | 1 | part by mass |
| (manufactured by Shin-Etsu Chemical Co., Ltd.) | | |

The coating liquid [1] for a charge transporting sublayer was applied onto the charge generating sublayer [1] through dip coating, to form a coating film. The coating film was dried at 120° C. for 70 minutes, to form a charge transporting sublayer [1] having a thickness of 20 μm.

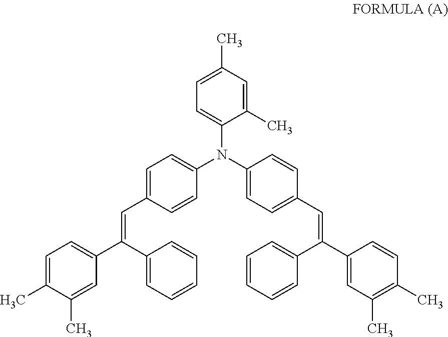

### (5) Formation of Protective Layer

| | | |
|---|---|---|
| P-type Semiconductor particles [1] | 100 | parts by mass |
| Cross-linked resin particles (melamine- | 30 | parts by mass |
| formaldehyde resin particles “Epostar S6” | | |
| having a number average primary particle size of | | |
| 0.5 μm) (manufactured by Nippon Shokubai Co., | | |
| Ltd.) | | |
| Polymerizable compound (exemplified compound | 100 | parts by mass |
| (M1)) | | |
| Polymerization initiator (“Irgacure 819,” | 15 | parts by mass |
| manufactured by BASF Japan Ltd.) | | |
| Solvent: 2-butanol | 400 | parts by mass |
| Solvent: methyl isopropyl ketone | 100 | parts by mass |

These raw materials were thoroughly mixed under stirring to prepare a coating liquid [1] for a protective layer.

The coating liquid [1] for a protective layer was applied onto the charge transporting sublayer with a circular slide hopper coater, to form a coating film. The coating film was then irradiated with UV rays with a metal halide lamp for one minute, to form a protective layer [1] having a dry thickness of 3.0 μm.

### Preparation Examples 2 to 10 of Photoreceptor

Photoreceptors [2] to [10] were produced in the same manner as in Preparation Example 1 of Photoreceptor, except that the composition of a coating liquid for a protective layer was modified as illustrated in Table 1.

TABLE 1

| | | PROTECTIVE LAYER | | | | | | | |
|---|---|---|---|---|---|---|---|---|---|
| | | P-TYPE | | | | | | | |
| | | SEMICONDUCTOR PARTICLES | | | | CROSS-LINKED RESIN PARTICLES | | | |
| | | (INORGANIC PARTICLES) | | | | | | | AMOUNT |
| | | | | PARTICLE | AMOUNT | | | PARTICLE | (PARTS |
| | PHOTORECEPTOR | | | SIZE B | (PARTS | | | SIZE A | BY |
| | No. | No. | TYPE | (μm) | BY MASS) | No. | TYPE | (μm) | MASS) |
| EXAMPLE 1 | 1 | [1] | CuAlO₂ | 0.05 | 100 | [1] | MELAMINE | 0.5 | 30 |
| EXAMPLE 2 | 2 | [2] | CuAlO₂ | 0.1 | 100 | [2] | MELAMINE | 0.2 | 20 |
| EXAMPLE 3 | 3 | [1] | CuAlO₂ | 0.05 | 100 | [1] | MELAMINE | 0.5 | 50 |
| EXAMPLE 4 | 4 | [4] | CuInO₂ | 0.1 | 100 | [4] | SILICONE | 0.8 | 30 |
| EXAMPLE 5 | 5 | [1] | CuAlO₂ | 0.05 | 150 | [3] | MELAMINE | 1 | 30 |
| EXAMPLE 6 | 6 | [3] | CuAlO₂ | 0.2 | 100 | [5] | PMMA | 0.2 | 30 |
| EXAMPLE 7 | 7 | [5] | CuInO₂ | 0.02 | 50 | [2] | MELAMINE | 0.2 | 30 |
| COMPARATIVE | 8 | [x] | SnO₂ | 0.02 | 100 | — | — | — | — |
| EXAMPLE 1 | | | | | | | | | |
| COMPARATIVE | 9 | [y] | Al₂O₃ | 0.03 | 150 | — | — | — | — |
| EXAMPLE 2 | | | | | | | | | |
| COMPARATIVE | 10 | [y] | Al₂O₃ | 0.03 | 100 | [2] | MELAMINE | 0.2 | 30 |
| EXAMPLE 3 | | | | | | | | | |

| | PROTECTIVE LAYER | | | | | |
|---|---|---|---|---|---|---|
| | | | | CHARGE | | |
| | | | | TRANSPORTING | POLYMERIZATION | |
| | | BINDER | | MATERIAL | INITIATOR | |
| | | RESIN | | (RCTM) | (Irg819) | |
| | | | AMOUNT | AMOUNT | AMOUNT | |
| | | | (PARTS | (PARTS | (PARTS | |
| | A/B | TYPE | BY MASS) | BY MASS) | BY MASS) | CURING |
| EXAMPLE 1 | 10 | M1 | 100 | — | 15 | PHOTOCURING |
| EXAMPLE 2 | 2 | M4 | 100 | — | 15 | PHOTOCURING |
| EXAMPLE 3 | 10 | Z300 | 100 | — | — | — |
| EXAMPLE 4 | 8 | M12 | 100 | — | — | PHOTOCURING |
| EXAMPLE 5 | 20 | M1 | 100 | — | 10 | PHOTOCURING |
| EXAMPLE 6 | 1 | M1 | 100 | — | 15 | PHOTOCURING |
| EXAMPLE 7 | 10 | M1 | 100 | — | 15 | PHOTOCURING |
| COMPARATIVE | — | M1 | 100 | — | 15 | PHOTOCURING |
| EXAMPLE 1 | | | | | | |
| COMPARATIVE | — | M1 | 100 | 100 | 15 | PHOTOCURING |
| EXAMPLE 2 | | | | | | |
| COMPARATIVE | 7 | M1 | 100 | 100 | 15 | PHOTOCURING |
| EXAMPLE 3 | | | | | | |

The materials shown in Table 1 are as follows:
Cross-linked resin particles [1]: melamine-formaldehyde resin particles “Epostar S6” (number average primary particle size: 0.5 μm) (manufactured by Nippon Shokubai Co., Ltd.)
Cross-linked resin particles [2]: melamine-formaldehyde resin particles “Epostar S” (number average primary particle size: 0.2 μm) (manufactured by Nippon Shokubai Co., Ltd.)
Cross-linked resin particles [3]: melamine-formaldehyde resin particles “Epostar S12” (number average primary particle size: 1.0 μm) (manufactured by Nippon Shokubai Co., Ltd.)
Cross-linked resin particles [4]: silicone resin particles “X-52-854” (number average primary particle size: 0.8 μm) (manufactured by Shin-Etsu Chemical Co., Ltd.)
Cross-linked resin particles [5]: cross-linked PMMA resin particles “SA PMMA” (manufactured by Miyoshi Kasei, Inc.)
Inorganic particles [x] SnO₂: tin oxide fine particles (number average primary particle size: 20 nm) surface-treated with a surface treating agent of exemplary compound (S-15)
Inorganic particles [y]: alumina particles (number average primary particle size: 0.03 μm) (manufactured by Nano Tec)
M4: exemplary polymerizable compound (M4)
Z300: polycarbonate resin “Z300” (manufactured by Mitsubishi Gas Chemical Company, Inc.)
M12: exemplary polymerizable compound (M12)
M13: exemplary polymerizable compound (M13)
Polymerization initiator (Irg 819): “Irgacure 819” (manufactured by BASF Japan Ltd.)
Charge transporting material (RCTM): charge transporting material represented by Formula (B).

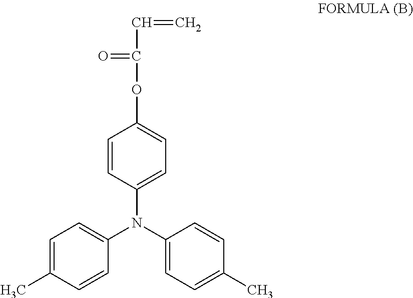

### Examples 1 to 7 and Comparative Examples 1 to 3

Each of the photoreceptors [1] to [10] was mounted in a modified machine including a charging roller, which is a modification of the charging unit of the image forming assembly of a commercial full-color multifunctional printer “bizhub C554” (manufactured by KONICA MINOLTA, INC.), the printer having basically the same configuration as that of the image forming apparatus illustrated in FIG. 1. Image forming apparatuses [1] to [10] were thereby produced.

The image forming apparatuses [1] to [10] were evaluated for wear resistance and image stability (uniformity of image density and generation of streaks).

### (1) Evaluation of Wear Resistance

A current twice the normal value was applied to the charging roller under low-temperature and low-humidity conditions (10° C., 20% RH), and character strings with a coverage rate of 5% were printed on 100,000 sheets. After this wear test, the thickness of the protective layer was measured with a thickness tester, to determine the amount of wear.

Table 2 shows the results. In the present invention, an amount of wear of less than 1.0 μm was determined to be accepted.

### (2) Image Stability (Uniformity of Image Density)

After the above-described wear test, a halftone image having a transmission density of 0.29 was printed on the entire surfaces of 20 size-A3 sheets under room temperature conditions (20° C., 50% RH). The halftone image on the 20th sheet was visually observed for evaluation of lateral uniformity of image density based on the following criteria.

### —Evaluation Criteria—

◯: No uneven image density (accepted)
Δ: Slightly uneven image density but practically acceptable (accepted)
×: Noticeably uneven image density (rejected)

### (3) Image Stability (Streaks)

After the above-described wear test, a solid black image was printed on the entire surfaces of 20 size-A3 sheets under room temperature conditions (20° C., 50% RH). Immediately thereafter, a halftone image was printed on the entire surface of a size-A3 sheet. The halftone image on the sheet was visually observed for evaluation of image stability (longitudinal streaks) based on the following criteria.

### —Evaluation Criteria—

◯: No streaks (accepted)
Δ: Slight streaks but practically acceptable (accepted)
×: Noticeable streaks (rejected)

TABLE 2

| | PHOTO- | RESULTS OF EVALUATION | | |
|---|---|---|---|---|
| | RECEP- | AMOUNT | UNIFORMITY | |
| | TOR | OF WEAR | OF IMAGE | |
| | No. | (μm) | DENSITY | STREAKS |
| EXAMPLE 1 | 1 | 0.41 | ∘ | ∘ |
| EXAMPLE 2 | 2 | 0.49 | ∘ | ∘ |
| EXAMPLE 3 | 3 | 0.89 | ∘ | ∘ |
| EXAMPLE 4 | 4 | 0.48 | ∘ | Δ |
| EXAMPLE 5 | 5 | 0.59 | ∘ | Δ |
| EXAMPLE 6 | 6 | 0.62 | Δ | ∘ |
| EXAMPLE 7 | 7 | 0.53 | ∘ | ∘ |
| COMPAR- | 8 | 1.5 | Δ | x |
| ATIVE | | | | |
| EXAMPLE 1 | | | | |
| COMPAR- | 9 | 2.8 | x | x |
| ATIVE | | | | |
| EXAMPLE 2 | | | | |
| COMPAR- | 10 | 2.1 | Δ | x |
| ATIVE | | | | |
| EXAMPLE 3 | | | | |

The entire disclosure of Japanese Patent Application No. 2014-046068 filed on Mar. 10, 2014 including description, claims, drawings, and abstract are incorporated herein by reference in its entirety.

Although various exemplary embodiments have been shown and described, the invention is not limited to the embodiments shown. Therefore, the scope of the invention is intended to be limited solely by the scope of the claims that follow.

What is claimed is:

1. An image forming apparatus comprising:
an electrophotographic photoreceptor;
a proximity-type charging unit to negatively charge a surface of the electrophotographic photoreceptor;
an exposing unit to form an electrostatic latent image on the surface of the electrophotographic photoreceptor;
a developing unit to develop the electrostatic latent image with a toner to form a toner image;
a transferring unit to transfer the toner image onto a transfer medium;
a fixing unit to fix the transferred toner image on the transfer medium; and
a cleaning unit to remove residual toner on the electrophotographic photoreceptor, wherein
the electrophotographic photoreceptor comprises a conductive support, a photosensitive layer formed over the conductive support, and a protective layer formed over the photosensitive layer; and
the protective layer of the electrophotographic photoreceptor contains a binder resin, a particulate P-type semiconductor, and a particulate cross-linked resin composed of an insulating cross-linked polymer.

2. The image forming apparatus according to claim 1, wherein the particulate P-type semiconductor is composed of a compound represented by Formula (1):
CuMO₂ Formula (1):
where M represents an element belonging to Group 13 of a periodic table.

3. The image forming apparatus according to claim 1, wherein the particulate cross-linked resin is selected from a particulate silicone resin, a particulate melamine-formaldehyde condensation resin, and a particulate cross-linked polymer containing poly(methyl methacrylate).

4. The image forming apparatus according to claim 1, wherein a ratio A/B of a number average primary particle size A of the particulate cross-linked resin to a number average primary particle size B of the particulate P-type semiconductor satisfies Formula (2):
2≦A/B≦10. Formula (2):

5. The image forming apparatus according to claim 1, wherein the binder resin contained in the protective layer of the electrophotographic photoreceptor is a cured resin prepared through photopolymerization of a compound having two or more radically polymerizable functional groups.

6. The image forming apparatus according to claim 1, wherein the proximity-type charging unit is a charging roller.

7. The image forming apparatus according to claim 1, wherein the particulate P-type semiconductor has a number average primary particle size of 0.02 to 0.1 μm.

8. The image forming apparatus according to claim 1, wherein the particulate P-type semiconductor is contained in an amount of 50 to 150 parts by mass relative to 100 parts by mass of the binder resin in the protective layer.

9. The image forming apparatus according to claim 1, wherein the particulate cross-linked resin has a number average primary particle size of 0.1 to 1.0 μm.

10. An image forming method to form an image using an electrophotographic photoreceptor, the method comprising:
negatively charging a surface of the electrophotographic photoreceptor;
forming an electrostatic latent image on the surface of the electrophotographic photoreceptor;
developing the electrostatic latent image with a toner to form a toner image;
transferring the toner image onto a transfer medium;
fixing the transferred toner image on the transfer medium; and
removing residual toner on the electrophotographic photoreceptor, wherein
the electrophotographic photoreceptor comprises a conductive support, a photosensitive layer formed over the conductive support, and a protective layer formed over the photosensitive layer; and
the protective layer of the electrophotographic photoreceptor contains a binder resin, a particulate P-type semiconductor, and a particulate cross-linked resin composed of an insulating cross-linked polymer.
